(19) United States
(12) Patent Application Publication
(10) Pub. No.: US 2014/0325422 A1
(43) Pub. Date: Oct. 30, 2014

(54) OPERATING SYSTEM FOR AND METHOD OF OPERATING A CONTROLLABLE TRANSFER DEVICE FOR HARVESTED GOODS

(71) Applicant: CLAAS AGROSYSTEMS KGAA MBH & CO KG, GUETERSLOH (DE)

(72) Inventors: TOMMY ERTBOLLE MADSEN, Virum (DK); SOEREN STEEN, Kokkedal (DK); KIM AMHILD, Copenhagen N (DK)

(73) Assignee: CLAAS AGROSYSTEMS KGAA MBH & CO KG, GUETERSLOH (DE)

(21) Appl. No.: 14/260,594

(22) Filed: Apr. 24, 2014

(30) Foreign Application Priority Data
Apr. 29, 2013 (EP) 13165695.1

(51) Int. Cl. G06F 3/0481; G06F 3/0488; G06F 3/0484

(52) U.S. Cl. CPC G06F 3/04815; G06F 3/0484; G06F 3/0488
USPC 715/771

(57) ABSTRACT

An operating system operates a controllable transfer device for harvested goods of an agricultural vehicle embodying a self-propelled harvester. The operating system includes a three-dimensional imaging device for capturing a real object and for deriving a three-dimensional data set for the real object and a touch-sensitive display unit for displaying an object and for receiving a touch input. The operating system is configured to generate three-dimensional data set based command signals corresponding to the interaction with the displayed object for operating the transfer device. The operating system allows for an easy and efficient way to operate the controllable transfer device, reducing the stress and workload for the operator.

### CROSS-REFERENCE TO A RELATED APPLICATION

The invention described and claimed hereinbelow is also described in European Priority Document EP 13 165595.1, filed on Apr. 29, 2013. The European Priority Document, the subject matter of which is incorporated herein by reference, provides the basis for a claim of priority of invention under 35 U.S.C. 119(a)-(d).

### BACKGROUND OF THE INVENTION

The present invention relates to an operating system for operating a controllable transfer device for harvested goods of an agricultural vehicle (e.g., a self-propelled harvester), an agricultural vehicle comprising the operating system and a method of operating a controllable transfer device of an agricultural vehicle using the operating system.

Harvested goods are commonly transferred from a first agricultural vehicle (e.g., a forage harvester), to a second agricultural vehicle (e.g., a trailer towed by a tractor), by use of a transfer device. Due to the relative movement between the agricultural vehicles, the transfer device is designed to be controllable by an operator of the first or second agricultural vehicle.

In order to support an operator, EP 2 266 383 A1 discloses a control arrangement for controlling the transfer of agricultural crop from a harvesting machine to a transport vehicle comprising a loading container. The control arrangement relies upon signals from a sensor arrangement that detects the fill level or the outer contours of the loading container and controls the position of the output end of a discharge device with respect to any of the harvesting machine, the ejection direction of the discharge device and the position of the transport vehicle with the loading container with respect to the harvesting machine automatically to successfully fill the loading container with the crop. The sensor arrangement is designed to detect the position of a second loading container, where the control arrangement is operated so that after detection of an overall sufficiently filled first loading container, the discharge device is automatically aligned to the second loading container based on the signals from the sensor arrangement.

This automatic alignment of the transfer device has the drawback, however, that in case of dust and bits of goods scattered in the air, the sensor arrangement may not be able to align the transfer device properly, in which case the operator needs to manually readjust the transfer device, which increases the workload for the operator.

### SUMMARY OF THE INVENTION

The present invention overcomes the shortcomings of known arts, such as those mentioned above.

To that end, the invention provides an operating system for a controllable transfer device for harvested goods of an agricultural vehicle such as a self-propelled harvester that improves the operating of the transfer device and a method for operating such a controllable transfer device for harvested goods of an agricultural vehicle, which improves the operation of the transfer device.

In an embodiment, the invention provides an operating system for operating a controllable transfer device for harvested goods of an agricultural vehicle such as a self-propelled harvester that comprises at least one three-dimensional imaging device for capturing a real object and for deriving a three-dimensional data set for the real object and, a touch-sensitive display unit for displaying an object and for receiving a touch input. The system is configured to generate three-dimensional data set based command signals corresponding to the interaction with the displayed object for operating the transfer device.

As used herein, an agricultural vehicle may be a combine harvester, a forage harvester, a transport vehicle, a tractor and/or a trailer for receiving and transporting harvested goods.

The operating system for operating a transfer device may be located on the agricultural vehicle with the transfer device or on another agricultural vehicle, for example, a tractor pulling a trailer to be filled via the transfer device.

The controllable transfer device may be an auger of a combine harvester or a spout of a forage harvester, and may comprise a controllable flap at its free end in order to at least partially control the transfer of the harvested goods.

The transfer device comprises a control unit for controlling the transfer device such as actuators moving the transfer device. The control unit is configured to generate control signals to move, for example, by rotating and/or tilting, the transfer device in a position desired for a transfer of harvested goods. The control unit controls the flap at the free end of the transfer device.

The operating system comprises at least one three-dimensional imaging device for capturing real objects in the real world in order to generate a displayable two-dimensional image to interact with. On capturing the real object, the three-dimensional imaging device, in particular, a processing unit of the three-dimensional imaging device derives a three-dimensional data set and/or a three-dimensional range image for the captured real object and calculates a distance for each pixel of the three-dimensional imaging device. The distance information relates to relative distance and/or an absolute distance. The three-dimensional imaging device captures real objects in real time. The derived three-dimensional data set comprises distance information and/or three-dimensional coordinates of the real object.

The distance information is defined relative to the operating system and/or the agricultural vehicle and/or absolute (e.g., as three-dimensional coordinates). The absolute distance information is generated together with a navigation system, such as a satellite based navigation system (e.g., global positioning system (GPS)). The navigation system provides three-dimensional coordinates for the three-dimensional imaging system and/or the agricultural vehicle, based on which the three-dimensional coordinates of the real object are calculated by determining the position distance and bearing of the real object relative to the three-dimensional imaging device and/or the agricultural vehicle.

The captured real object is visualized for displaying on a display unit in a form of a range image. The visualisation of the captured object in a form of a live image and/or live video or in a form of an artificial video and/or artificial image suitable for visualising the captured distance information to an operator of the operating system. For each visualized and displayed pixel on the display unit, corresponding distance information is calculated. A pixel of the three-dimensional imaging device is the smallest capturable point of the image resolution of the imaging device, wherein a pixel of the display unit is the smallest addressable element of the display unit. The resolution of the three-dimensional imaging device is preferably higher than the resolution of the display unit, wherein the three-dimensional data set preferably corresponds to the higher resolution of the three-dimensional imaging device.

The display unit is preferably a multifunctional display unit configured to receive touch input, e.g., multi touch input up to and including multi touch input with five fingers. The multifunctional display comprises several subareas in a form of a split screen for independently displaying information and independently receiving touch input. The multifunctional display comprises additional input elements like buttons and/or wheels. The display unit receives data from the three-dimensional imaging device for displaying a captured and visualized real object and/or a virtual element. Objects, for example, in a form of a live video of a real object or in a form of a virtual element, displayed on the display unit are displayed objects. A three-dimensional data set corresponds to each particular captured and/or visualized, displayed object. Displayed objects may be enlarged on the display unit.

The display unit displays the captured and visualized objects and, receives and/or detects feedback in a form of touch input corresponding to a displayed object. The touch input is received in a form of detected two-dimensional coordinates relating to the executed touch input, such as the executed input gesture. The touch input is in a form of several different input gestures. The response of the operating system to the different input gestures is predefined. The displayed object is interacted with by touch input. The interaction with the displayed object is by manipulating the displayed object by hand with at least one finger by touch input. The displayed object is selected, moved and/or altered in shape and/or size. An interaction is displayed on the display unit in real time, thus allowing for an interactive manipulation of the displayed object.

The received touch input, for example a selection or a manipulation of the displayed object, is transmitted to the imaging device in a form of the two-dimensional coordinates. The imaging device, in particular, the processing unit of the three-dimensional imaging device, allocates the received feedback, e.g., two-dimensional coordinates of the touch input, to the displayed object displayed at those coordinates. The three-dimensional imaging device evaluates the received feedback and correlates the feedback to the corresponding displayed object and the related three-dimensional data set. The three-dimensional imaging device generates three-dimensional data set based command signals corresponding to the received two-dimensional touch input. The commands signals are received by the control unit of the controllable transfer device as input signals for operating the transfer device accordingly, for example, leaving the transfer device longer allocated to a trailer in order to automatically increase the filling level of harvested goods or for selecting an order in which several trailers are to be filled automatically by the operating system.

The command signals comprise position information of real objects, which may be necessary as input for the control unit in order to correctly position the transfer device. The displayed object is interactively manipulable, wherein a two-dimensional manipulation of the displayed object corresponds to the generating of three-dimensional control commands. The control commands are transmitted to the control unit of the transfer device in order to move the transfer device as desired, for example, in order to change a hit location of the transferred goods and/or to increase a filling level of transferred goods in a trailer.

The generating of three-dimensional data set based command signals corresponding to an interaction with the displayed object for operating the transfer device has the advantage that the operator can manually interact with visual information provided by the three-dimensional imaging device. The visual information enables the operator to supervise automated, transfer process of harvested goods and the manipulation of the displayed objects allows for a direct interaction with the transfer process and/or device, if a readjustment or other input is necessary. Thus, the operating system allows for an easy and efficient way to operate the controllable transfer device, reducing the stress and workload for the operator.

In an embodiment, the operating system is configured for generating command signals in a form of control signals for the transfer device for directly controlling the transfer device. The three-dimensional imaging device is directly linked to the controllable transfer device including actuators moving the transfer device to control the transfer device directly. The command signals generated by the imaging device, in particular, based on received touch input feedback, are control signals that are directly controlling the actuators of the transfer device. For example, the transfer device or a displayed stream of ejected harvested goods being transferred is selected by touch input. A movement by touch input leads to a directly linked movement of the transfer device and of the stream of ejected harvested goods being transferred. This has the advantage that the transfer device may be controlled directly by the three-dimensional imaging device and allows for a faster response of the transfer device movement to touch input by the operator on the display unit. In addition, the direct interaction with the displayed object for operating the operating system improves the ease of handling of the system further.

Preferably, the operating system is configured for recognizing a captured real object. The operating system comprises a memory unit for storing reference data corresponding to real objects. The captured real object, in particular, the derived three-dimensional data set corresponding to the real object, is compared to predefined reference data in order to enable recognition of a real object, for example whether it is a trailer and/or which type of trailer it is. If a captured real object is recognised, corresponding object data, for example, the dimensions of the real object like length, height and/or width, are allocated to the real object and/or displayed object and provided for the control of the transfer device. The object data are pre-stored on the memory unit, which has the advantage that precise data about the real object is efficiently made available to increase the precision of the transfer process without increasing the workload of the operator.

In an embodiment, the operating system is configured for allocating and/or changing data corresponding to a displayed object. The captured real object, in particular, the derived three-dimensional data set corresponding to the real object, is compared to predefined reference data in order to enable recognition of a real object, for example, whether it is a trailer or which type of trailer it is. In case a captured real object shown as a displayed object on the display unit has not been recognised, the operator may allocate object data retrieved from the memory unit to the displayed object corresponding to the real object.

A displayed object also may be generated and displayed for a real object that has transmitted its position to the operating system, for example, in a form of three-dimensional coordinates. The real object transmits an. identifier together with the information about its position. The identifier enables an identification of the real object, for example, what type of object it is. The object data corresponding to the real object that has transmitted its position and an identifier to the operating system is retrieved from the memory unit in order to reduce the data that needs to be transmitted. Such real object may be another agricultural vehicle, for example, a transport vehicle or a tractor with a trailer.

The displayed object may be corrected by the operator, where necessary. This has the advantage that the transfer of harvested goods is more efficient due to a better filling of a previously unrecognised trailer for example. The object data is changed, for example, in case the real object has been wrongly recognised or alterations to the object data are necessary. The allocation and/or changing of data corresponding to a displayed object is executed by touch input, in particular, by an input gesture on the display unit by altering the displayed object. This has the advantage that the operator may easily and more efficiently operate the transfer device, thereby reducing the workload for the operator.

In an embodiment, the operating system is configured for generating a visual and/or audible feedback, in particular, to a touch input. A touch input for selecting and/or manipulating a displayed object may cause an audible and/or visual feedback in order to indicate to the operator the execution of the desired action. The audible and/or visible feedback is given by a visual indication on the display unit, an indicator light and/or an audible signal like a tone or a message. This has the advantage that the operator gets a distinct feedback to his input.

Preferably, the operating system is further configured for generating at least one virtual element corresponding to a displayed object. The virtual element is generated by the three-dimensional imaging device and displayed on the display unit, for example, overlaying a displayed real object. The virtual element is interactively manipulable by touch input. A displayed object may be a real object, for example, a live image and/or video, and/or a virtual element. A virtual element is generated according to a recognised and displayed real object, for example, in a form of an artificial image of the real object, a symbol, or graphical elements.

The object data corresponding to the displayed real object may, for example, comprise information about the dimensions of a trailer, the maximum filing height and/or information about security distances indicating how close to a wall of the trailer the transfer device may transfer harvested goods. A virtual element representing the walls and/or safety distances of the recognized trailer is shown as displayed objects, virtual elements, overlaying a live image of the trailer.

The object data may be changed in case the real object has been wrongly recognised or alterations to the object data are necessary, by interacting with the virtual element. For example, the security distances of the trailer, limiting the movement of the transfer device, may be altered by selecting and moving them by touch input, widening or narrowing the area available for the transfer device to transfer goods, thus generating command signals for the control unit, allowing the transfer device to be moved and operated accordingly. The advantage of a virtual element is an increase in information that may be shown to the operator without increasing the workload. Additionally further interactions can be incorporated into the operating system, enhancing the input options for the operator.

In an embodiment, the three-dimensional imaging device comprises at least one electro-optical range imaging device such as a stereo camera, a light detecting and ranging device and/or a time-of-flight camera. The electro-optical range imaging device can be an active and/or passive range imaging device for generating an interactive two-dimensional image of a captured three-dimensional real world and/or a three-dimensional real object showing the distance to individual points in a scene of the real world from the electro-optical range imaging device. The light detection and ranging device, i.e., Laser Imaging Detection and Ranging (LIDAR or LADAR), is an active optical remote sensing technology that measures a distance to an object, like the ground or a real object, by illuminating the target with laser light and analyzing the backscattered light.

The time-of-flight camera, as an active range imaging device, resolves distance based on the known speed of light, measuring the time-of-flight of a light signal between the camera and a real object for each point of the image. The three-dimensional imaging device might be radar or ultra-sonic based range imaging device. Different kinds of three-dimensional imaging devices may be combined. A resulting three-dimensional data set may, for example, be visualised as a corresponding range image. Therein, the range image comprises pixel values each corresponding to a distance. The range image is visualized from the three-dimensional data set by the three-dimensional imaging device in order to provide an image displayable on the display unit for the operator, for example, in a form of a live image and/or video of the real world and/or object. The stereo camera, as a passive range imaging device, derives the three-dimensional data set and the corresponding pixel values for a real object directly from the captured image. The range image may be assembled from separate three-dimensional data sets and/or range images, for example, in a form of a panoramic picture. Therein, the individual range images originate from one or more, even different, three-dimensional imaging devices. This has the advantage that the field of view may be enlarged.

The invention further relates to an agricultural vehicle comprising at least one operating system as described above. The inventive operating system allows for an easy and efficient way to operate the controllable transfer device, reducing the stress and workload for the operator.

A further aspect of the invention is a method of interactively operating using an operating system as described above, a controllable transfer device for harvested goods of an agricultural vehicle such as a self-propelled harvester. The method comprises steps of

deriving a three-dimensional data set for a real object captured by a three-dimensional imaging device,

displaying an object on the touch-sensitive display unit,

receiving feedback from the display unit from touch input interaction with the displayed object, and

generating three-dimensional data set based command signals corresponding to the interaction with the displayed object for operating the transfer device.

A three-dimensional imaging device captures an image of a real object in the real world for deriving a three-dimensional data set for the captured real object. The three-dimensional data set comprises information such as position information about the distance of the real object to the imaging device and/or the agricultural vehicle. Each pixel of the captured image of the imaging device comprises distance information from the real object to the imaging device. The three-dimensional data set comprises relative and/or absolute position information and/or three-dimensional coordinates. The three-dimensional coordinates are generated by support of a navigation system such as a satellite based navigation system, for example, the global positioning system (GPS).

The navigation system provides three-dimensional coordinates for the three-dimensional imaging system and/or the agricultural vehicle based on which the three-dimensional coordinates of the real object Is calculated by determining the position, for example, distance and bearing of the real object relative to the three-dimensional imaging device and/or the agricultural vehicle. Visualizing the captured real object provides a displayable image of the image captured by the imaging device. The visualisation of the real object is in a form of a live and/or an artificial image and/or video of the real object. This allows for a presentation of the three-dimensional information that is easily absorbed by an operator of the agricultural vehicle operating the transfer device. For displaying the visualised captured real object, information is transmitted from the imaging device to a touch sensitive display unit. The visualised captured real object is displayed as a displayed object on the display unit. Therein, several objects are displayed in one or more subareas of the display unit separately and/or together. The display unit is sensitive to multi touch input for each subarea and/or displayed object.

A displayed object may be interacted with by touching the touch sensitive display unit in the area showing the displayed object. The interacting may be in a form of selecting the displayed object and/or by manipulating the displayed object, for example, its shape and/or dimensions. The touch input is registered as feedback by the display unit in two-dimensional coordinates. The two-dimensional coordinates of the feedback and the interaction with the displayed object are transmitted back to the three-dimensional imaging device. The three-dimensional imaging device correlates the two-dimensional coordinates to the three-dimensional data set corresponding to the displayed object. Based on the interaction with the displayed object, command signals for operating the transfer device according to the Interaction are generated, based on the three-dimensional data set.

The command signals are transferred as input signals to a control unit controlling the transfer device. The generated command signals comprise three-dimensional data set based information corresponding to the touch input, for example, three-dimensional coordinates of a selected position or an intended movement of the transfer device, which are then transmitted as input signals to the control unit. The control unit controls the transfer device accordingly in order to execute the movement and/or operation intended by the interaction with the displayed object. For example, a hit location where harvested goods are to be dumped on a displayed object in a form of a trailer is selected by touch input. The two-dimensional coordinates of the touch input are transmitted to the imaging device, which correlates these two-dimensional coordinates to a three-dimensional coordinate based on the three-dimensional data set of the displayed trailer. This three-dimensional coordinate is then transmitted as input signals to a control unit controlling the transfer device, so that the control unit positions the transfer device accordingly in order to transfer the harvested goods to the hit location selected by the operator.

The generating of three-dimensional data set based command signals corresponding to an interaction with the displayed object for operating the transfer device has the advantage that the operator may manually interact with visual information provided by the three-dimensional imaging device for operating the transfer device. The visual information enables the operator to supervise a, for example, automated, transfer process of harvested goods and the manipulation of the displayed objects allows for a direct interaction with the transfer process in order to execute readjustments or other input if necessary. Thus, the operating system allows for an easy and efficient way to operate the controllable transfer device, reducing the stress and workload for the operator.

In an embodiment, the method comprises the step of generating command signals in a form of control signals for directly controlling the transfer device. The command signals are generated in a form of control signals that are transmitted directly to at least one actuator of the transfer device in order to directly control the movement of the transfer device. Thus, the interaction with the displayed object by touch input is directly transferred into control signals for directly controlling at least one actuator of the transfer device.

This has the advantage that the transfer device is controlled directly by the three-dimensional imaging device, which allows for a faster response of the transfer device movement to touch input by the operator on the display unit. For example, the displayed object of the stream of ejected harvested goods being transferred is interacted with on the touch sensitive display so that the stream is selected by a corresponding input gesture and dragged to another position. As such, the transfer device and the stream of ejected harvested goods being transferred are directly responding and moving according to the touch input.

In an embodiment, the method comprises the step of recognising a captured real object. A captured real object, in particular, the derived three-dimensional data set corresponding to the real object, is compared to predefined reference data in order to enable recognition of a real object. The reference data is pre-stored on a memory unit. When recognising a real object by comparing the derived three-dimensional data set with reference data, corresponding object data is allocated to the captured real object and provided for controlling the transfer device. The object data is pre-stored on the memory unit. Object data may, for example, be the precise dimensions of the real object, like height, width, length, the load capacity, filling height, etc. This has the advantage, that precise data about the real object is efficiently made available for operating the transfer process and/or device, thus, increasing the precision of the transfer process without Increasing the workload of the operator.

In an embodiment, the method comprises the step of storing and/or retrieving reference data for comparing a derived three-dimensional data set with reference data. Reference data is retrieved and used for comparing the derived three-dimensional data set from a captured real object with pre-stored data. In case a real object is not recognized, e.g., where no reference data is available, the derived three-dimensional data set of the captured unrecognized real object is stored in the memory unit as reference data. This could be the case if a new type of trailer is used for receiving the harvested goods. The stored reference data is complemented with further, more precise information about the real object, for example, from a data sheet of the real object. This has the advantage, that an unrecognised real object may only need to be stored once in order to automatically recognise it afterwards, thus, reducing the workload for the operator.

In an embodiment, the method comprises the step of allocating and/or changing data corresponding to a displayed object. The data corresponding to a displayed object may be a three-dimensional data set, object data and/or reference data. In case a captured real object that is shown as a displayed object has not been recognized, object data is allocated to the displayed object by the operator. The allocated object data may, for example, be retrieved from the memory unit.

In case a captured real object that is shown as a displayed object has not been recognised correctly, the object data allocated to the displayed object may be changed by the operator. The change is implemented by retrieving the correct object data from the memory unit and/or by altering the object data, for example, by touch input, on the display unit. A displayed object also may be generated and displayed for a real object that has transmitted its position to the operating system in a form of three-dimensional coordinates.

The real object transmits an identifier together with the information about its position. The object data corresponding to the real object that has transmitted its position to the operating system is retrieved from the memory unit in order to reduce the data that needs to be transmitted. Such real object may be another agricultural vehicle, for example, a transport vehicle or a tractor with a trailer. The displayed object may be corrected by the operator. This has the advantage, that the transfer of harvested goods is more efficient due to more precise data, for example, the filling height, of a previously unrecognised trailer.

Preferably, the method further comprises the step of generating a visual and/or audible feedback in response to a touch input. Interacting with the displayed object, in particular, by touch input, is supported by audio and/or visual feedback in order to indicate the execution of the desired action. The audible and/or visible feedback is given by a visual indication on the display unit, an indicator light and/or an audible signal like a tone or a message. This has the advantage that the operator gets a distinct feedback to his input.

In an embodiment, the method comprises the step of generating at least one virtual element corresponding to a displayed object. The virtual element is generated by the three-dimensional imaging device and displayed on the display unit. The virtual element is laid over the visualized real object, i.e., as an overlay. The virtual element is interactively manipulable by touch input. A displayed object may be a real object such as a live image and/or video and/or a virtual element. The virtual element is generated according to a displayed and recognised real object, for example, in a form of an artificial image of the real object, a symbol, or graphical elements.

For generating a virtual element, object data corresponding to the displayed and recognized real object is incorporated by incorporating object information into the virtual element, like an indication of the maximum filling height or security distances indicating how close to a wall of the trailer the transfer device may transfer harvested goods. A virtual element representing the walls and/or security distances of the recognized trailer is shown as a displayed object, in a form of virtual elements, laid over a live image of the trailer. The interaction with the displayed object, for example, in a form of a virtual element, is transferred into three-dimensional data set based command signals by transmitting the altered security distances in a form of, in particular, relative, three-dimensional coordinates to the control unit. This enables the control unit to move and operate the transfer device according to the new security distances. The advantage of a virtual element is an increase in information that may be shown to the operator without increasing the workload. Additionally, further interactions can be incorporated into the operating system, enhancing the input options for the operator.

### BRIEF DESCRIPTION OF THE DRAWINGS

Further features and advantages of the invention will become apparent from the description of embodiments that follows, with reference to the attached figures, wherein:

FIG. 1: presents a schematic view of agricultural vehicles with an operating system according to the invention;

FIG. 2: presents a schematic view of an operating system according to the invention;

FIG. 3: presents image of selecting a trailer;

FIG. 4: presents a view highlighting interacting with a transfer device;

FIG. 5: presents a view highlighting interacting with a virtual element;

FIG. 6: presents a view highlighting changing of object data;

FIG. 7: presents a view highlighting selecting of a hit location; and

FIG. 8: present an image of a trailer.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

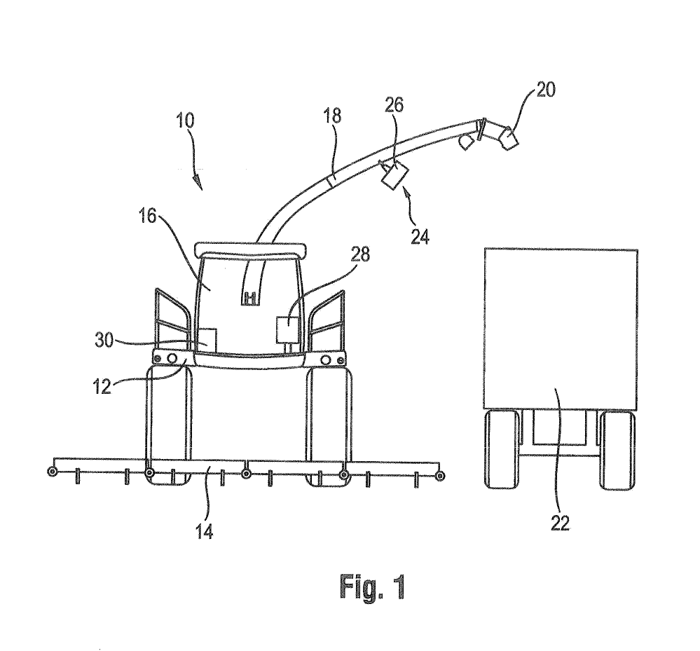

FIG. 1 illustrates a schematic view of two agricultural vehicles, wherein the operating system 10 is mounted on a forage harvester 12, shown in a front view. The forest harvester comprises a header 14, a cabin 16 and a controllable transfer device 18 with a controllable flap 20 at its free end. During operation, the harvested goods are processed by the harvester 12 and ejected through the transfer device 18. In order to collect the harvested goods, a trailer 22 is arranged next to the harvester 12 within reach of the transfer device 18. A three-dimensional imaging device 24 with an electro-optical range imaging device in a form of a stereo camera 26 for capturing real objects, such as the trailer 22, is attached to the transfer device 18, facing the trailer 22. The three-dimensional imaging device 24 is overlooks and captures at least part of the trailer 22. The three-dimensional imaging device 24 is connected to a touch sensitive display unit 28 for displaying a visualised image of the real object captured by the stereo camera 26. The controllable transfer device 18 is rotatable and tillable mounted on the harvester 12. The transfer device 18 and the flap 20 are controllable by a control unit 30, configured to receive command signals from the three-dimensional imaging device 24.

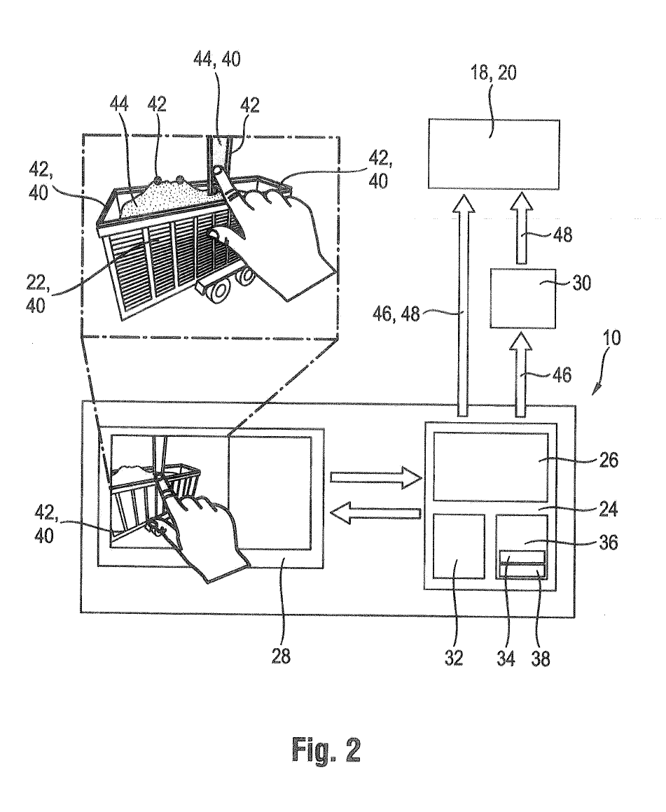

In FIG. 2, a schematic view of the operating system 10 is illustrated. The stereo camera 26 of the three-dimensional imaging device 24 captures a real object in a form of the trailer 22. The three-dimensional imaging device 24 comprises a processing unit 32 for deriving a three-dimensional data set for the captured real object in a form of the trailer 22. The captured real object is visualised for display on the touch sensitive display unit 28. Visualizing means processes the captured information from the three-dimensional imaging device 24 into a displayable and visually recognizable form for an operator of the operating system 10.

The three-dimensional data set is compared with reference data 34 stored in a memory unit 36 of the three-dimensional imaging device 24. If the real object is recognised, based on the comparing of the generated three-dimensional data set with the stored reference data 34, object data 38 corresponding to the recognized real object is allocated to the object. The object data 38 also is stored in the memory unit 36. The object data 38 comprises additional information about the real object, for example, what type of trailer 22 it is, the precise dimensions of the trailer, height of the side walls of the trailer 22, maximum filling height, etc., without limitation.

The visualized information of the captured real object is transmitted to the display unit 28 and shown as a displayed object 40 in at least part of the touch sensitive display unit 28 (the displayed live image of the real object is shown enlarged in FIG. 2). The displayed object 40 is a live image and/or video, a synthetic image and/or a virtual element 42. The virtual element 42 comprises and visualizes additional information about a displayed object 40, in this case, the trailer 22. The virtual element 42 is shown as a rectangular frame indicating the borders of the side walls of the trailer 22. The filling height is indicated by virtual elements 42 in a form of colored dots, representing the position of heaps of transferred harvested goods 44 as well as the filling height due to their position and their colour. The vertical borders of the stream of ejected harvested goods 44 being transferred are also indicated by virtual elements 42.

The displayed objects 40 are interactively manipulable by touch input, in particular, by predefined input gestures. The harvested goods 44 ejected from the transfer device 18 are selected by touch input, for example, with the index finger, and may be moved or otherwise interacted with. This touch input is transmitted back to the three-dimensional imaging device 24 as feedback comprising the two-dimensional coordinates of the touch input. If, for example, the operator were to move or drag the selected displayed object 40, in this case the stream of ejected harvested goods 44 being transferred, the three-dimensional imaging device 24 generates three-dimensional data set based command signals 46 according to the interaction with the displayed object 40 for operating the transfer device 18 accordingly.

The control commands 46 are sent to the control unit 28 of the transfer device 18 in order to control and operate the transfer device 18 accordingly, for example, holding the transfer device 18 in a defined position until a certain height of harvested goods 44 is reached and then automatically moving the transfer device 18 to a next position, selectable by touch input, wherein the three-dimensional coordinates are generated based on the two-dimensional touch input. Thus, control commands 46 may be commands for operating the transfer device 18 in a certain way, in particular chronologically independent from the touch input. A special type of command signals 46 are control signals 48, generated to directly control at least one actuator for moving the transfer device 18.

The control signals 48 are generated by the control unit 30 and/or the three-dimensional imaging device 24, in particular, the processing unit 32 of the three-dimensional imaging device 24. In the case of the selected stream of ejected harvested goods 44 transferred, the dragging of the stream could, according to the input gesture, result in the transfer device 18 being moved in real time to follow the interaction with the displayed object 40 of the harvested goods 44 in a form of a touch input on the display unit 28.

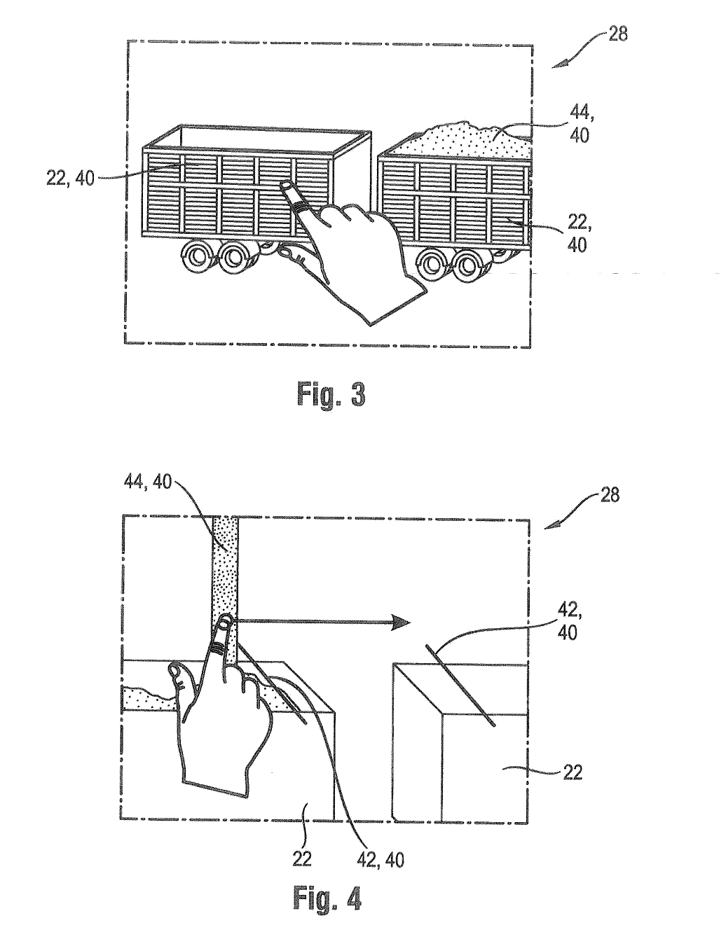

The selecting of a second trailer 22 is shown in FIG. 3. The first trailer 22 is filled with harvested goods 44 and the empty second trailer 22 is selected by interacting with the displayed object 40, representing the empty second trailer 22. The touch input is transmitted to the three-dimensional imaging device 24 which generates control commands 46 for positioning the transfer device 18 accordingly in order to fill the second trailer 22 with harvested goods 44. The selecting and dragging of the stream of harvested goods 44 is shown in FIG. 4. According to the object data 38 corresponding to the recognised trailer 22, security distances are shown as virtual elements 42, indicating the limits for the transfer of harvested goods 44 and thus for the positioning of the transfer device 18. By dragging the selected stream of ejected harvested goods 44 being transferred across the security distances, for example, to the right in the direction shown towards the empty trailer 22, an override function in order to cross the security distances is activated, moving the transfer device 18 towards the possibly yet unrecognised empty trailer 22. An allocation of object data to the empty trailer 22 could be executed by touch input.

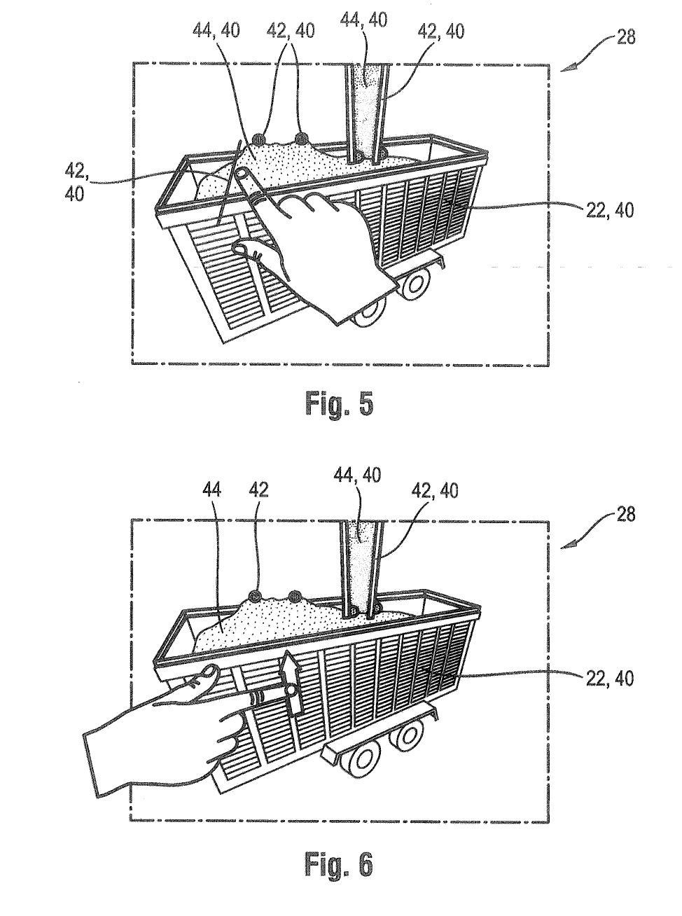

A selected displayed object 40 in a form of a virtual element 42 representing a security distance may be moved to a desired new position, for example, further towards the end of the trailer 22, by touch input (FIG. 5). The interacting with the virtual element 42 by moving the virtual element 42 leads to an alteration of the object data 38 corresponding to the displayed trailer 22. The two-dimensional change in the position of the virtual element 42 correlates to a three-dimensional change in the coordinates of the security distance deposited In the object data of the trailer 22, which is changed and stored in the memory unit (not shown). The filling height of the trailer 22 shown in FIG. 6 may be altered, for example, increased, after selecting the virtual elements 42 and by executing an appropriate input gesture, for example, an upward swiping. The filling height might be increased for one or more selected heaps of harvested goods 44 or in total. An increase of the filling height might be desirable in case of dry and thus less heavy harvested goods, so that a maximum payload of the trailer can be used efficiently. A decrease of the maximum filling height might be desirable in case of damp or wet and thus heavy harvested goods, so that the maximum payload of the trailer is not exceeded.

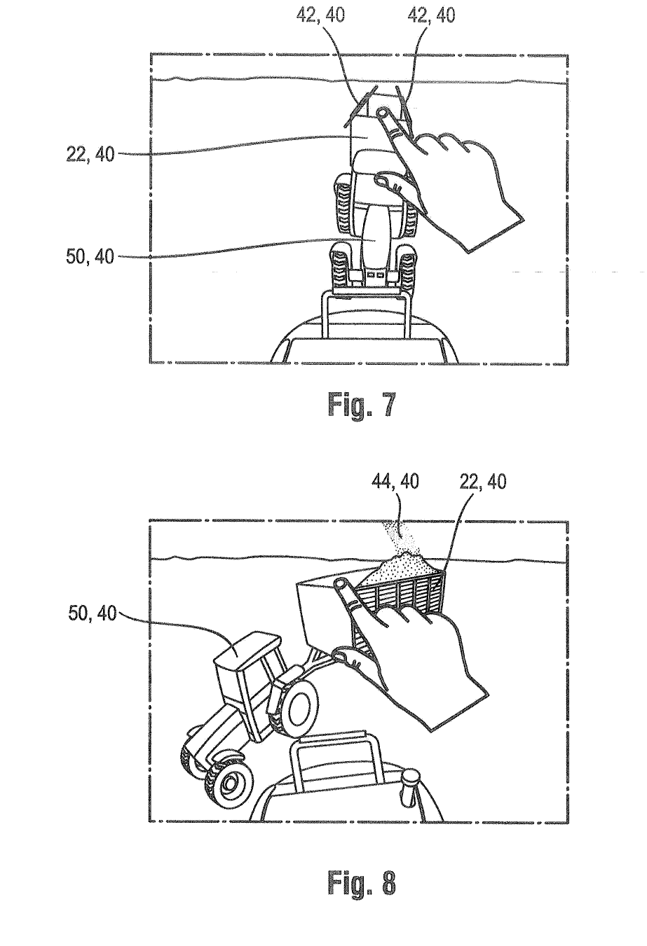

In FIG. 7, the transfer device 18 faces to the rear of the forage harvester and towards a tractor 50 with a trailer 22. The trailer 22 is recognized and corresponding security distances are displayed as virtual elements 42, indicating the lateral borders for filling the trailer 22. The hit location, where the ejected harvested goods 44 are to be thrown to, is selected by touching the desired location on the displayed object 40, the trailer 22. The two-dimensional coordinates of the touch input are used by the three-dimensional imaging device 24 for generating control commands 46 comprising the corresponding three-dimensional coordinates of the hit location. The hit location also may be selected by interacting with the displayed object 40, wherein the displayed object 40 may be unrecognised and no additional information is shown in a form of a virtual element (FIG. 8). In this case the two-dimensional input coordinates are transferred to three-dimensional command controls based on the three-dimensional data set of the captured and displayed, unrecognised real object.

### LIST OF REFERENCE SIGNS

10 Operating system

12 forage harvester

14 header

16 cabin

18 transfer device

20 flap

22 trailer

24 three-dimensional imaging device

26 stereo camera

28 display unit

30 control unit

32 processing unit

34 reference data

36 memory unit

38 object data

40 displayed object

42 virtual element

44 harvested goods

46 command signal

48 control signal

50 tractor

As will be evident to persons skilled in the art, the foregoing detailed description and figures are presented as examples of the invention, and that variations are contemplated that do not depart from the fair scope of the teachings and descriptions

set forth in this disclosure. The foregoing is not intended to limit what has been invented, except to the extent that the following claims so limit that.

What is claimed is:

1. An operating system for operating a controllable transfer device for harvested goods of an agricultural vehicle embodying a self-propelled harvester, comprising:
at least one three-dimensional Imaging device for capturing a real object and for deriving a three-dimensional data set for the real object; and
a touch-sensitive display unit for displaying an object and for receiving a touch input;
wherein the operating system is configured for generating three-dimensional data set based command signals corresponding to an interaction with the displayed object for operating the transfer device.

2. The operating system according to claim 1, further configured for generating command signals in a form of control signals for the transfer device for directly controlling the transfer device.

3. The operating system according to claim 1, further configured for recognising a captured real object.

4. The operating system according to claim 1, further configured for allocating and/or changing data corresponding to a displayed object.

5. The operating system according to claim 1, further configured for generating a visual and/or audible feedback in response to a touch input.

6. The operating system according to claim 1, further configured for generating at least one virtual element corresponding to a displayed object.

7. The operating system according to claim 1, wherein the three-dimensional imaging device comprises at least one electro-optical range imaging device in a form of a stereo camera, a light detection and ranging device, a time-of-flight camera or a combination thereof.

8. An agricultural vehicle comprising at least one operating system for operating a controllable transfer device for harvested goods, the operating system comprising:
at least one three-dimensional imaging device for capturing a real object and for deriving a three-dimensional data set for the real object; and
a touch-sensitive display unit for displaying an object and for receiving a touch input;
wherein the operating system is configured for generating three-dimensional data set based command signals corresponding to an interaction with the displayed object for operating the transfer device.

9. A method of interactively operating using an operating system for operating a controllable transfer device for harvested goods that comprises at least one three-dimensional imaging device for capturing a real object and for deriving a three-dimensional data set for the real object and touch-sensitive display unit for displaying an object and for receiving a touch input, the operating system configured for generating three-dimensional data set based command signals corresponding to an interaction with the displayed object for operating the transfer device, the method comprising the steps of:
deriving a three-dimensional data set for the real object captured by the three-dimensional imaging device;
displaying the object on the touch-sensitive display unit;
receiving feedback from the display unit from touch input interaction with the displayed object;
generating the three-dimensional data set based command signals corresponding to the interaction with the displayed object for operating the transfer device.

10. The method according to claim 9, further comprising a step of generating command signals in a form of control signals for directly controlling the transfer device.

11. The method according to claim 9, further comprising a step of recognizing a captured real object.

12. The method according to claim 9, further comprising a step of storing or retrieving reference data for comparing a derived three-dimensional data set with reference data.

13. The method according to claim 9, further comprising a step of allocating data, changing data or both corresponding to a displayed object.

14. The method according to claim 9, further comprising a step of generating a visual feedback, audible feedback or both in response to a touch input.

15. The method according to claims 9, further comprising a step of generating at least one virtual element corresponding to a displayed object.
